(19) United States
(12) Patent Application Publication
(10) Pub. No.: US 2007/0055872 A1
(43) Pub. Date: Mar. 8, 2007

(54) Secure processor

(75) Inventors: Masakazu Soga, Iwate (JP); Toshimitsu Inomata, Iwate (JP)

Correspondence Address: RADER FISHMAN & GRAUER PLLC, LION BUILDING, 1233 20TH STREET N.W., SUITE 501, WASHINGTON, DC, 20036, US

(73) Assignee: Japan Science and Technology Agency, Saitama (JP)

(21) Appl. No.: 10/578,258

(22) PCT Filed: Nov. 9, 2004
(86) PCT No.: PCT/JP04/16589

§ 371 Date: May 4, 2006

(30) Foreign Application Priority Data
Nov. 10, 2003 (JP) 2003-380114

(51) Int. Cl. H04L 9/00

(52) U.S. Cl. 713/168

(57) ABSTRACT

A processor having a general-purpose function and a security dedicated function (i.e., safe keeping of key data and high-speed digital signature calculation) is provided. Key data is stored in a non-volatile key register 130 of a secure processor 100, which has general instructions and signature calculation instructions. A key bit reference counter 152 decreases by one from 1023 to 0 sequentially. In conformity with the content of this key bit reference counter 152, a bit designating gate 154 designates k data stored in the non-volatile key register 130 bit by bit, which is then used for sequential signature calculation. A word data parallel transmission path, which allows data to be transferred from the key register 130 to others, is not provided. With such a hardware structure, it is impossible to directly output raw key data to the outside.

### TECHNICAL FIELD

The present invention relates to a general-purpose microprocessor architecture (logical structure). It particularly relates to architecture of a microprocessor utilized for security techniques such as a digital signature.

### BACKGROUND ART

The functionality and performance of the processors have improved to an order of one million times that of 60 years since the advent of computers. This improvement mainly emanates from improved functionality and performance of device elements and circuits. Secondarily, it also emanates from improved architecture. Most of such improved architecture has contributed to an improvement in performance. During the last 20 years or so, quite a few parts of architecture improvement has been for improving reliability and decreasing consumed power. However, architecture improvement for improving security has just begun (e.g., Palladium initiative, LaGrande initiative, Enhanced Virus Protection function).

Note that processors dedicated to calculating for public key based codes (e.g., calculation for RSA ciphering) are available for improvement in security. They include security-dedicated processors made by IBM Corporation, Fujitsu Ltd., Matsushita Industrial Co., Ltd, NTT Data Corporation, etc. They are dedicated auxiliary processors that take on calculation only for signatures and codes, premising that a general-purpose main processor also exists. Since all of the dedicated processors are originally functionality-limited processors that take on calculation for signatures and codes, a risk that key data may be used for other purposes can be avoided.

See, for example, Non-Patent Reference 1 for the RSA ciphering algorithm.

NON-PATENT REFERENCE 1: Cetin Kaya Koc “High-Speed RSA Implementation Version 2.0” RSA Data Security, Inc. 1994

(ftp://ftp.rsasecurity.corn/pub/pdfs/tr201.pdt)

### DISCLOSURE OF INVENTION PROBLEM THAT THE INVENTION TO SOLVE

The objective of the present invention is to provide a processor having general purpose functions and security functions (i.e., safe keeping of key data and high-speed digital signature calculation).

### MEASURE TO SOLVE THE PROBLEM

To attain the objective described above, the present invention is a secure processor including: a key register including non-volatile memory stored with key data; a key counter configured to indicate a bit position of the key data stored in the key register to access the key data bit by bit; a digest register configured to be stored with digest data to be used for digital signature; and a gate configured to output 1 for the content of the digest register when the corresponding bit of the key data accessed by the key counter is 0 and output the content of the digest register as is when the bit of the key data is 1; wherein no path for reading all data out from the outside is prepared for the key register, and the secure processor further comprises a plurality of signature dedicated instructions for controlling the key register, the key counter, and the digest register to obtain a digital signature based on the digest data, as well as general instructions.

This allows provision of a processor having a security function, which prohibits key data stored in the key register of non-volatile memory from being read directly, as well as a general function.

Running modes of this processor include a general mode and a security mode. The processor includes a security register configured to indicate the security mode and has a general instruction for setting the security mode and a signature dedicated instruction for resetting the same. The general instruction is effective during the general mode while the signature dedicated instruction is effective during the security mode.

The instruction for setting the security mode causes to set the security register and initializes the key counter to 1023 at the same time while the signature dedicated instruction causes to decrease the key counter by one at the same time when an instruction for conducting signature calculation for one bit of the key register and causes to reset the security mode only when the key counter is 0 resulting from the signature calculation progressing bit by bit. This makes it impossible to leave a digital signature calculation process until the process is completed (i.e., until the key counter becomes 0) once having entered the digital signature calculation process. Therefore, it is impossible to estimate key data from intermediary results of the calculation using a program.

A means for detecting that each 16 bits of digest data stored in the digest register includes at least one ‘1’ may be provided. The instruction for setting the security may cause to initialize the key counter when at least one ‘1’ is included in each 16 bits, and also may cause to prevent change in data in the digest register after a security flag SF0 is set to 1. This prohibits the key data from being read out indirectly.

The secure processor is connected to main memory. The signature dedicated instruction may cause to store results of digital signature calculation only in a specific area of the main memory and overwrite the results of the digital signature calculation over results of previous calculation. This makes it impossible to keep the intermediary results in the main memory.

With an IC card including the secure processor described above, it is possible to conduct signature calculation within the IC card. Therefore, it is not necessary to retrieve the key data outside of the IC card, securing safe running of signature calculation. Furthermore, it is impossible to retrieve the key data from the IC card using a program.

### RESULTS OF THE INVENTION

The secure processor according to the present invention solves the issue of trade-offs between general purpose functions and security functions using a new architecture.

A main function of the IC card for individual authentication using the secure processor described above is signature calculation. The secure processor according to the present invention can conduct signature calculation using its own security function, and furthermore, can run general application programs for a cache card function, a credit card function, an alteration prevention function, a toll payment function, a ticket reservation function, etc.

### BRIEF DESCRIPTION OF DRAWINGS

FIG. 1 is a block diagram showing an exemplary structure of a secure processor;

FIG. 2 is a block diagram showing s section for reading key data out;

FIG. 3 shows an exemplary format of instructions of the secure processor;

FIG. 4-1 shows a part of an OP code table for the secure processor;

FIG. 4-2 shows a continuation of the OP code table for the secure processor and further shows field symbols of OP codes, description of representations of operations, etc.;

FIG. 5 is a flowchart showing signature calculation;

FIG. 6 shows a case of conducting Montgomery Multiplication using instructions of the secure processor; and

FIG. 7 shows exemplary structures of IC cards using the secure processor.

### BEST MODE FOR CARRYING OUT THE INVENTION

In essence, the security function for individual authentication allows use of private key data only for signature calculation but prohibits every other operation from being performed. To actually achieve this, a secure processor according to the present invention comprises the following two operating structures roughly classified.

A: When using private key data for signature calculation or the like, there is only an operation of sequential access from the upper bits bit by bit. From this viewpoint, a private key is stored in an independent dedicated non-volatile register other than the main memory or a general purpose register; wherein that dedicated register does not have a path that allows all data to be read out from the outside and a dedicated path used for bit-by-bit calculation from the upper bits is provided instead.

B: A security mode, which the conventional processors never have, is introduced to the secure processor. This is a constraint for the environment in which programs run. This security mode does not allow interpretation of general instruction words as instructions and instead allows special instruction words only used for signature calculation to function as instructions.

With these operating structures, it is impossible for the secure processor according to the present invention to allow any kind of program to leak private key data.

An exemplary structure of the secure processor having both the above-mentioned functionalities A and B is described in detail forthwith with reference to the appended drawings.

<Structure of Processor>

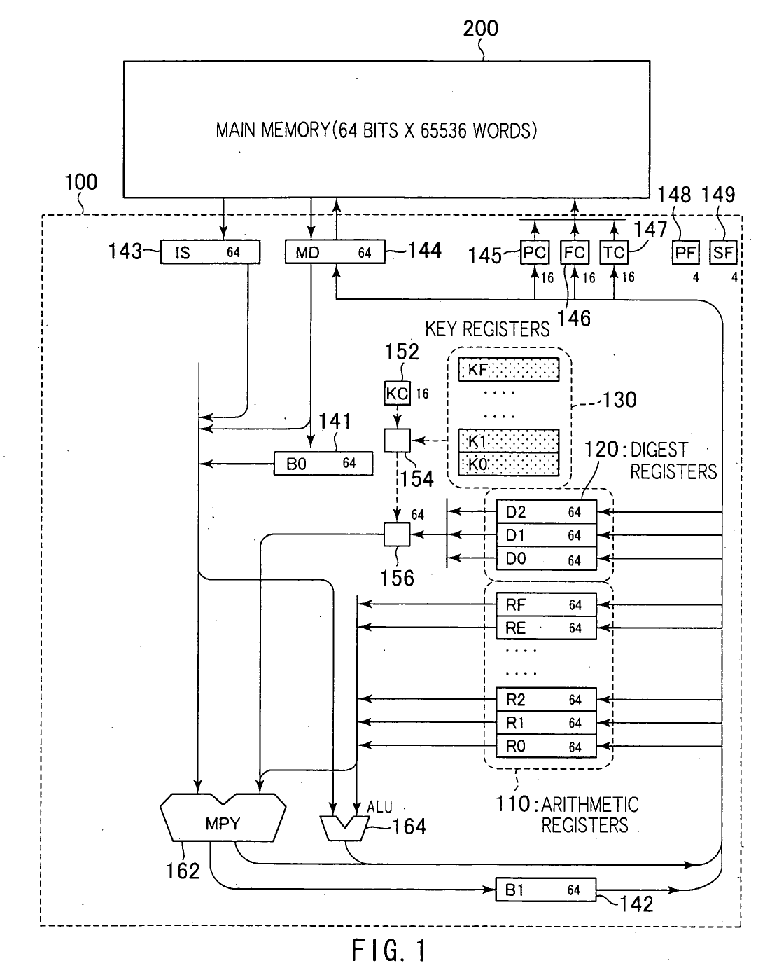

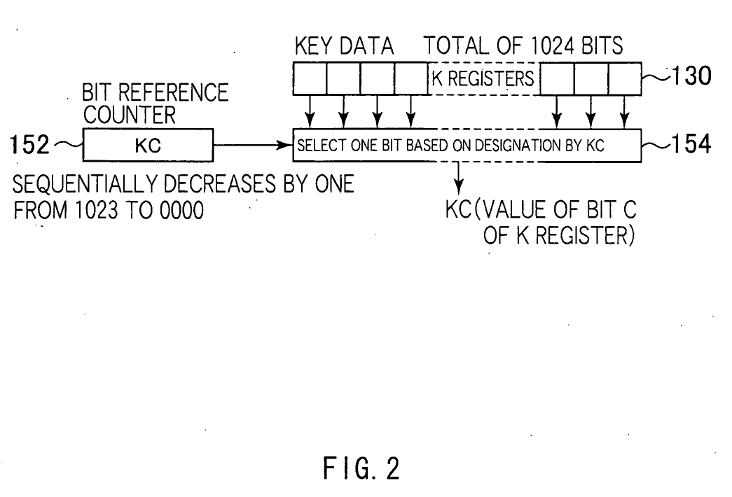

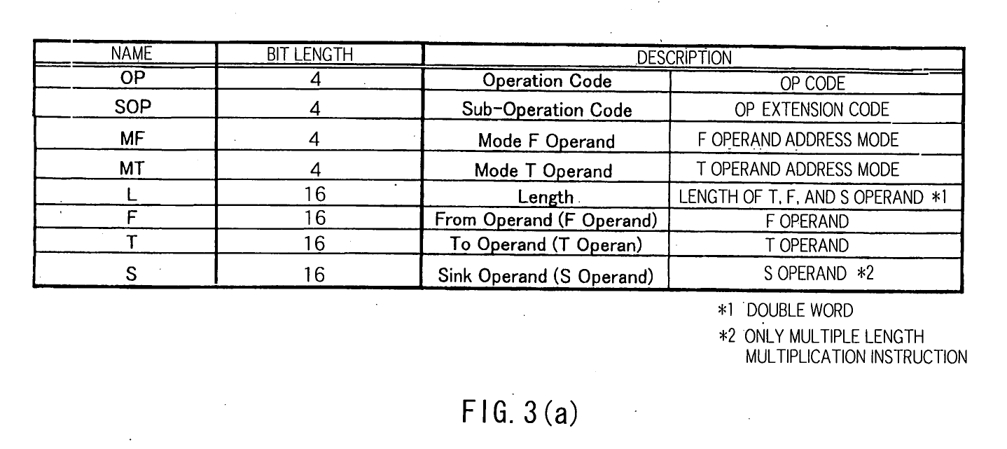

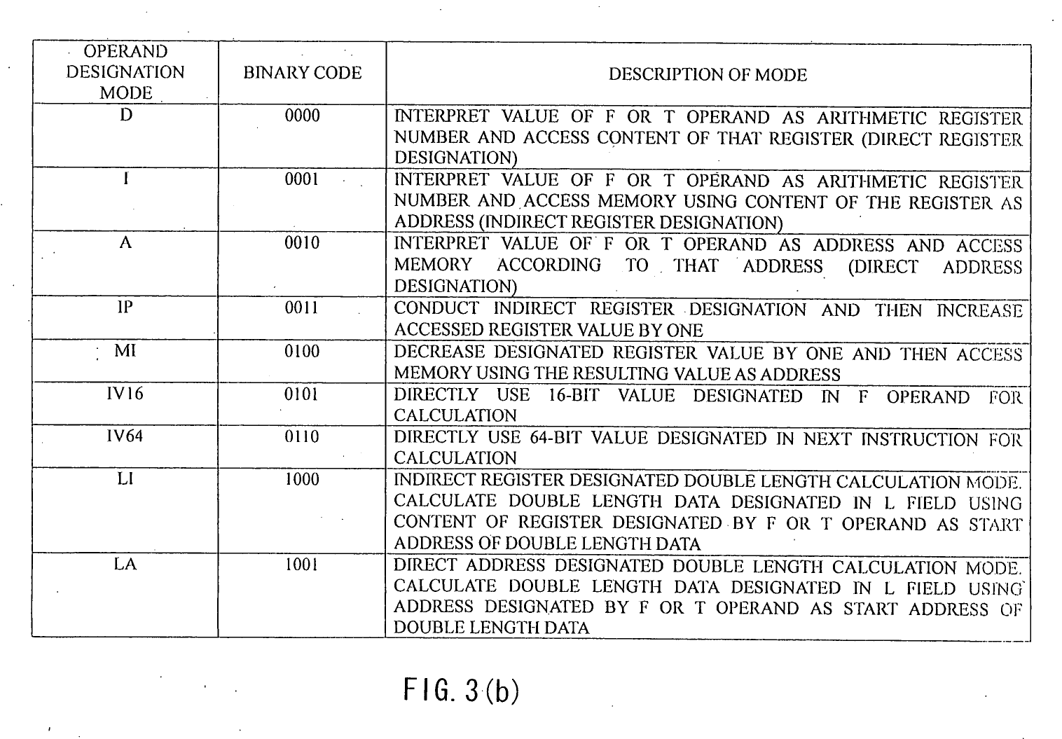

FIG. 1 is a block diagram of an embodiment of a secure processor. FIG. 2 is a block diagram of a key register and related circuits in the secure processor. FIG. 3 shows instruction formats of the secure processor of the embodiment. FIGS. 4-1 and 4-2 show exemplary OP codes (instruction codes) of the secure processor.

<Internal Structure of Secure Processor>

A processor 100 shown in FIG. 1 has a relatively long word length (64 bits) for signature calculation and can calculate up to 16-double length words based on only a single instruction. The unit for addresses for a main memory 200 is also a unit of word length (i.e., a unit of 64 bits). The capacity of the main memory is 64 bits multiplied by 64K words (i.e., 512 KB=4M bits). These are described later.

Note that while the secure processor described below has a unit of word length of 64 bits, which emanates from the fact that the longest possible word length has been selected through consideration of signature calculation with key data, that unit may be decided based on the calculation speed and the amount of hardware.

(Description of Exemplary Internal Structure of Secure Processor)

The CPU 100 shown in FIG. 1 includes an instruction register (IS) 143, a memory data register (MD) 144, a program counter (PC) 145, an F-operand counter (FC) 146, and a T-operand counter (TC) 147. These are in between the main memory 200 and registers from/to which instructions and data are read out and written.

Instructions in formats (of 64 bits) shown in FIG. 3(a) are read out to the instruction register (IS) 143 from the main memory 200 based on the content of the program counter (PC) 145. In conformity with each of these instructions, addresses or the like according to an addressing mode (see FIG. 3(b)) designated by the MF or MT field shown in FIG. 3(a) are set to the F-operand counter 146 and the T-operand counter 147, and data is read out to the memory data register (MD) 144 from the main memory 200, or data stored in the memory data register 144 (MD) is written to the main memory 200.

Double length arithmetic instructions instruct the F-operand counter 146 and the T-operand counter 147 to increase one by one the number of times represented by the word length designated in an L field of FIG. 3, resulting in reading operands out from the main memory 200 one after another or writing to the same. In such a manner, processing up to 16-double length words is possible based on a single instruction.

An arithmetic and logic unit (ALU) 164 is a computing unit to perform general operations (such as addition, subtraction, and logic operations). A multiply unit (MPY) 162 is a computing unit to multiply 64 bits by 64 bits.

A program status flag 148 is a 4-bit flag that is set by executing an instruction; more specifically, the items of the program status word (PSW) column in OP code tables shown in FIGS. 4-1(a) and 4-2(b) are set. N, Z, V, and C of the PSW column in the OP code tables represent negative, zero, overflow, and carry, respectively.

Arithmetic registers (R0 to RF) 110 are general registers used for general arithmetic instructions or the like. With the arithmetic instructions using these general registers, ‘register direct’ in FIG. 3(b) is set to the MF or the MT in FIG. 3(a), and a register number is set to the F or the T-operand field. Buffer registers (B0 and B1) 141 and 142 are registers that are stored with intermediary calculation results.

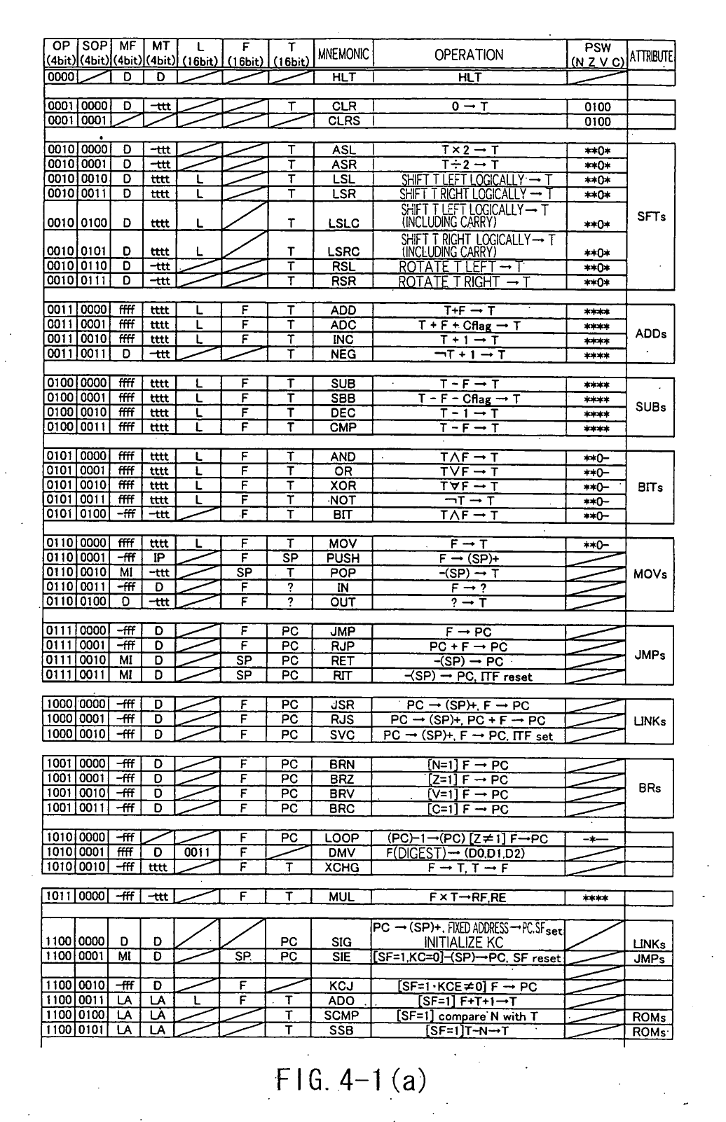

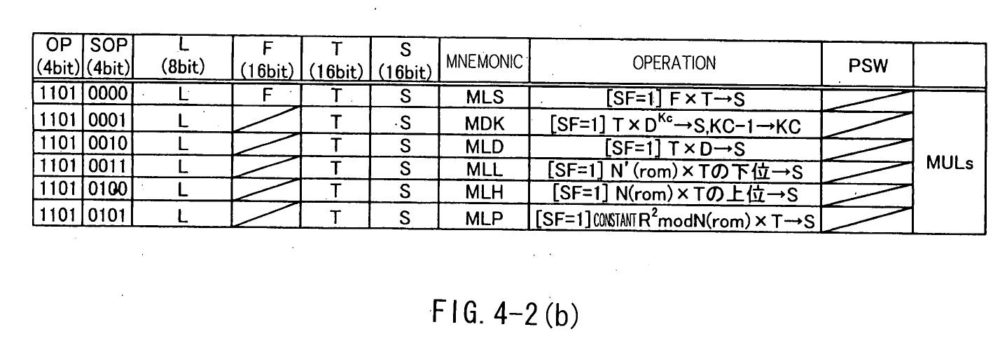

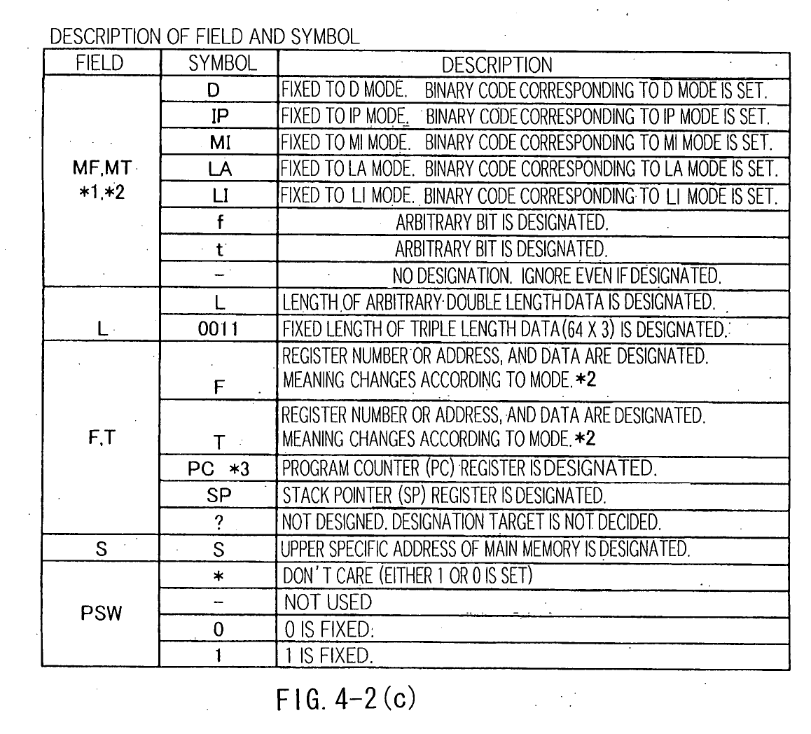

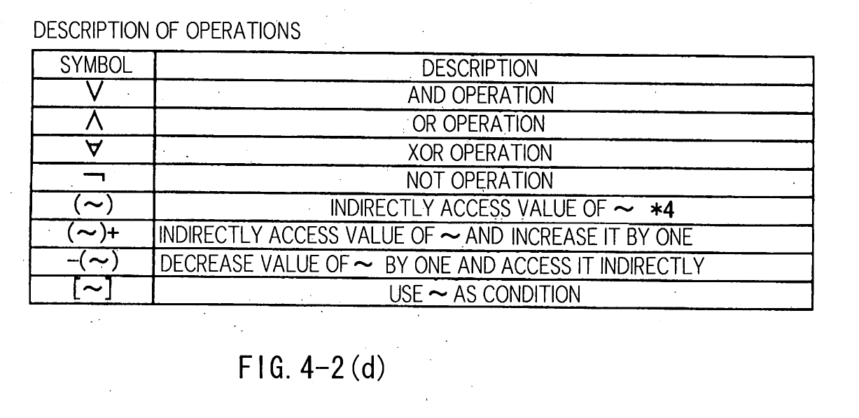

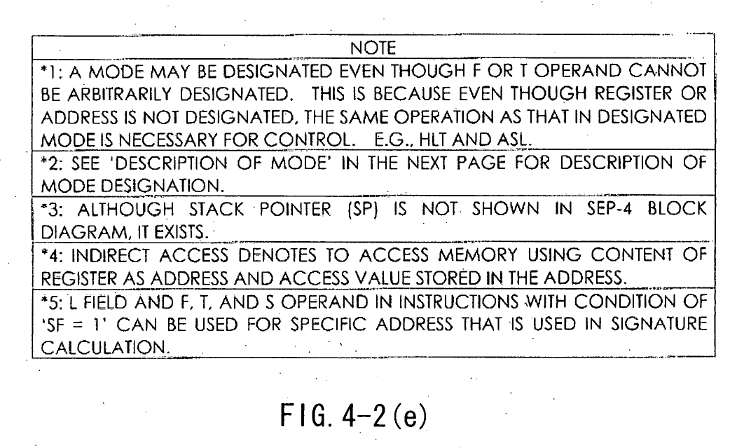

For more detail of the operations for the above-mentioned instructions and functions of respective registers, please see the instruction formats in FIGS. 3-1 and 3-2 and the OP code tables (instruction code tables) of FIGS. 4-1 and 4-2. FIGS. 4-1 (a) and 4-2(b) are OP code tables, FIG. 4-2(c) provides a description of symbols used in respective fields of the OP code tables, FIG. 4-2(d) provides a description of the operations for respective symbols in the OP code tables, and FIG. 4-2(e) provides a supplementary description of notations with ‘*’ in FIGS. 4-2(c) and 4-2(d).

For more detail of the items in the OP, SOP, MF, MT, L, F, T, and S columns of the OP code tables, please see the description of the instruction formats in FIGS. 3(a) and 3(b) and description of the symbols in FIG. 4-2(c). Mnemonics are abbreviations for respective instructions and they are hereafter used to refer to the respective instructions. The operations for the respective instructions are described in the ‘OPERATION’ column. The ‘ATTRIBUTE’ column shows classification of instructions: ‘SFT’ represents shift instructions, ‘ADD’ represents add instructions, ‘SUB’ represents subtract instructions, ‘BIT’ represents bit processing instructions, ‘MOV’ represents move instructions, ‘JMP’ represents jump instructions, ‘LINK’ represents subroutine call instructions, and ‘BR’ represents PSW-based branch instructions. Note that SVC instructions denote supervisor call instructions and set an IP flag not shown in FIG. 1. ‘RIT’ denotes return instructions for those supervisor call instructions, which reset the IT flag.

Note that the aforementioned OP code tables include instructions for signature calculation described below, which are described later.

The structure described above is the same as that of conventional general-purpose microprocessors. This may be modified according to application field of this secure processor. In order to make great use of a 64-bit word based structure, an instruction effective in performing the ‘mod’ operation that is prepared for signature calculation, which is described below, may be provided as a general instruction for encryption.

<Structure of Signature Calculation>

The structure described below is an exemplary structure focused on signature calculation in a secure processor.

(Prevention of Key Data Leakage)

One of the aims for security functions is to prevent leakage of key data. In FIG. 1, the key data is stored in key registers K0 to KF (130) that are constructed from non-volatile memory (e.g., ROM). The key registers 130 are stored with, for example, RSA secret key data of 1024 bits for respective users. Writing a key to this non-volatile memory may be performed by, for example, an external dedicated writer.

The calculation method for a digital signature using the RSA public key cryptosystem needs to access bit by bit of a key K from the upper bits and use each of them for another multiplication. This is the only usage. Accordingly, as shown in FIG. 2, a key reference circuit to select and reference bit by bit from the key register 130 is provided for that purpose. An algorithm for calculating digital signatures using that circuit is described in detail later.

With the key reference circuit of FIG. 2, a key-bit reference counter (KC) 152 in the key reference circuit sequentially decreases by one from 1023 to 0. In conformity with the content of the key-bit reference counter 152, K data stored in the key register 130 is designated bit by bit and referenced via a bit designating gate 154. As is also apparent from FIG. 2, a word data parallel transmission circuit to transfer data from the key register 130, which is stored with a key K, to other circuits is not provided. As is shown in FIG. 1, the output of the bit designating gate 154 is used only by an output selecting gate 156 for digest registers 120. Therefore, from the viewpoint of the hardware structure shown in FIGS. 1 and 2, it is impossible to directly provide raw key data to the outside.

The digest registers D0 to D2 (120) in FIG. 1 are three 64-bit registers used to store digest data (160-bit characteristic data) extracted from a text to be attached with a digital signature for digital signature processing.

Before digital signature processing, 160-bit digest is created from the text and then stored in the main memory 200. The digest is compressed and shuffled (using a hash function SHA-1, for example) into 160 bits arranged in a random bit structure irrelevant to the bit-based structure of the text. However, a simple value may be intentionally set as this digest data. This, however, develops a risk that a key K may be counted backward from the results of signature calculation for 2. To prevent this, it is necessary to detect that the content of the digest register is not a simple value such as 2ⁿ (n=1, 2, . . . ). When a small prime number such as 2, 3, 5, 7, 11, 13, 17, 19, 23, . . . is set as the digest data and the results of signature calculation are collected in advance, a risk that the results of signature calculation for relatively freely collected digest data using these results may be synthesized develops. To prevent this development, it is necessary to assure that the digest data value is great enough to correspond to 160 bits. With the secure processor, non-risk values are referred to as an “effective pattern” and used as a condition for starting signature calculation.

In conformity with an instruction DMV in the OP code table of FIG. 4-1, the three-word digest stored in an address of the main memory 200 designated in the F field is stored in the digest registers (D registers) 120.

The D registers 120 are attached with bit-pattern detecting gates (not shown in the drawings). The bit-pattern detecting gates for which all 160 bits in the D registers 120 are divided into 10 blocks, each including 16 bits, detect whether the all of the blocks include at least one ‘1’. Thus, whether the stored data is an “effective pattern” is detected.

Single-bit key data read out by the key reference circuit described above influences the digest data D read out from the D registers 120 via a D determination gate 156. This is described in the following SIGNATURE CALCULATION section.

(Security Mode)

From the hardware structure of the key registers 130 described above and the key reference circuit, it is obvious that the key data K as is cannot be transmitted to the outside. The remaining questions are whether it is possible to measure and collect the values for respective bits of key data used indirectly during the aforementioned calculation and to collect results of some kinds of signature calculation and then synthesize a signature for an arbitrary digest value. It is well known that if a target to be observed is the final result of complex signature calculation (total of 1024 bits), estimation of key data is practically impossible because it is digital signature data. Another method for preventing estimation of the K value (either 0 or 1) based on results of Montgomery Multiplication for each bit is described below. A prevention method for synthesis is described later.

To distinguish signature calculation from other conventional calculations and prevent misuse of instructions, which are used during signature calculation, for other purposes than for signatures, a secure processor distinguishes a program running mode from a normal mode. A security flag register (SF register) 149 indicates which mode is the current running mode.

The SF register 149 in FIG. 1 has 4 bits: SF3, SF2, SF1, and SF0; however, only the SF0 is used at this time.

(1) SF0=0: Normal Mode

Application program section, personal computer interaction section, and compressed calculation section

(2) SF0=1: Signature Mode

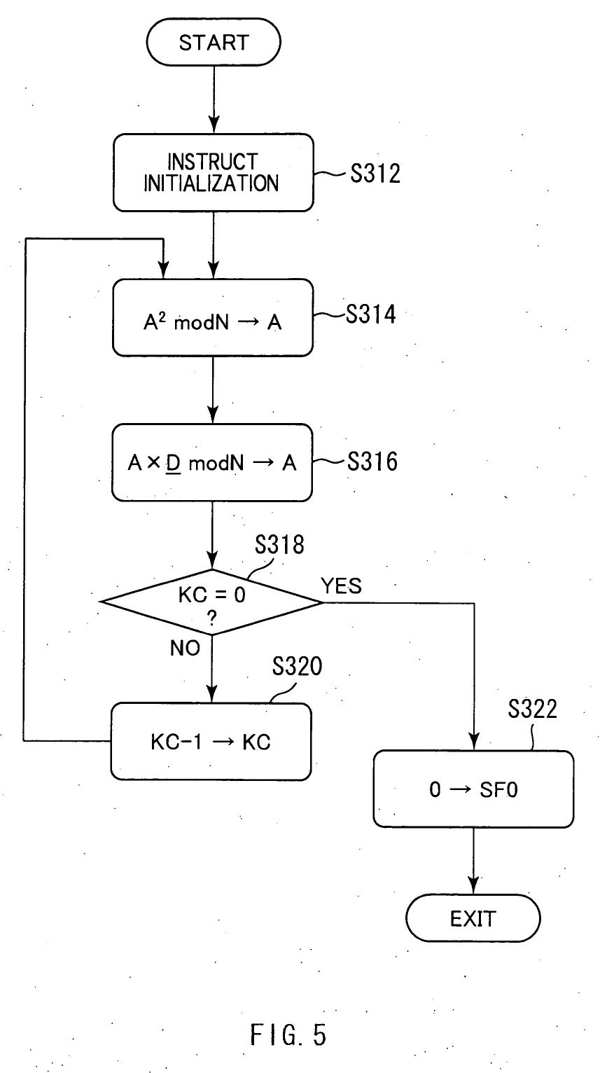

Under signature calculation (see a flowchart of FIG. 5 described later)

General instructions in an instruction set cannot be effective unless the security flag SF0 is 0. Instructions to be used only during signature calculation are prepared as a part of the instruction set. These instructions cannot be effective unless SF0 is not 1. Note that they are regarded as no operation instructions: NOP when the value of the SO does not match. In the OP code tables of FIGS. 4-1(a) and 4-2(b), instructions expressed with ‘SF=1’ in corresponding ‘OPERATION’ columns denote those instructions and include SWE, KCJ, ADO, SCMP, SSB, MLS, MDK, MLD, MLL, MLH, and MLP. Note that each of the instructions: MLS, MDK, MLD, MLL, MLH, and MLP has an S field that designates the start address for storing a calculation result and is different in format from the other instructions.

An instruction SIG (shown in FIG. 4-1(a)), which sets ‘1’ to SF0, always sets ‘03FF’ (equal to a decimal number of 1023) to KC and also sets 1024-bit data ‘0000 . . . 0001’ to addresses 0000 to 000F at the same time. A SIG instruction is not effective unless the content of the digest register 120 is an effective value. This prevents backward calculation of key K using 2^{K} mod N with ‘2’ set to the digest register 120.

The addresses at which calculation results are stored during signature calculation are the following fixed upper 64 addresses of the main memory.

(1) 0000-000F: 16 addresses (1024-bit data)

(2) 0010-001F: 16 addresses (1024-bit data)

(3) 0020-002F: 16 addresses (1024-bit data)

(4) 0030-003F: 16 addresses (1024-bit data)

When calculation results are 1024 bits, they are stored in the 16 addresses ranging from 0000 to 000F (1). When calculation results are 2048 bits, they are stored in 32 addresses ranging from 0000 to 001F (1) and (2). Temporarily saving calculation results is allowed only in addresses ranging from 0020 to 003F (3) and (4). Note that once the SF0 having the value of 1 is reset to 0, a general MOV instruction or the like (see FIG. 4-1 (a)) can be used to move the contents of the aforementioned fixed, upper addresses to other addresses.

An SF0 resetting instruction SEE cannot be executed until signature calculation is completed or until the key counter KC changes to 0 (see FIG. 4-1(a)). This is described in detail later.

Therefore, since the calculation results for each bit are accumulated only in fixed addresses, it is impossible to retrieve intermediary results for each bit. Only the final results for the entire bits can be retrieved.

(Signature Calculation)

Digital signature in the RSA public-key cryptosystem is based on calculation of D^{K} mod N (where D denotes digest data, K denotes a key, and N denotes a specific integer).

A very long special instruction covering D^{K} mod N is preferable for security. However, it is not preferable for hardware resources. Accordingly, multiple special instructions having almost the same length as those of general instructions are prepared and executed. This may allow change in usage of these special instructions and development of a hostile program for leakage of key K. The aforementioned security function is used to prevent this from occurring. With this security function, calculation of D^{K} mod N is described using a flowchart of FIG. 5. The flowchart of FIG. 5 shows a case of processing based on an algorithm of the Binary Method; for more details, see Non-Patent Reference 1 (2.3 The Binary Method (pp. 10 to 11)) described above, for example. Note that ‘A’ in the flowchart represents the content of addresses 0000 to 000F of the memory.

In the flowchart of FIG. 5, three initial operations necessary for initial setting (S312): setting ‘1’ to SF0, setting ‘1’ to A, and setting ‘1023’ to KC are performed using a single instruction SIG. Afterwards, a subroutine for signature calculation is executed.

Note that it is allowed to set the SF when a condition that the content of the digest register 120 should be an effective pattern is satisfied. The effective pattern denotes 160-bit data that is shuffled and compressed in the digest register. For example, hardware may detect at least one ‘1’ from each 16 bits of 10 multiplied by 16 bits. Since only the instructions used for signature calculation can function after the SF0 becomes 1, changing data in the digest register 120 is impossible.

A countermeasure against attacks (well-known as Desmedt-Odlyzko multiplicative attack) by which the calculated signature value for an arbitrary digest value described above is synthesized using calculated signature values for collected, multiple simple digest values is described forthwith.

Collection of calculated signature values based on small primary numbers such as 2, 3, 7, 11, 13, develops a risk of the calculated signature value of M^{K} mod N for an arbitrary digest value M being synthesized without a direct signature. In other words, factorizing M to represent the M as the product of small primary numbers A, B, C,:M=A^{P}B^{Q}C^{R} . . . and then collecting signature values U, V, W, . . . based on A, B, C, respectively in advance makes it easy to synthesize

M^{K} mod N=(A^{P}B^{Q}C^{R} . . . )^{K} mod N=U^{P}V^{Q}W^{R} . . . mod N

without directly knowing the value of K.

However, according to this method, since selection of primary numbers such as 2, 3, 5, 7, 11, 13, is prohibited by conducting effective pattern check for digest values, pre-collection of results of signature calculation itself is protected.

There is another risk that a target signature value may be obtained by using a method well-known as Blind signature scheme to multiply a small prime number by a random number R, converting it to a larger number so that effective pattern check can be avoided, followed by obtaining a signature value, which is then divided by that R, thereby providing a target signature value. In this case, use of the Blind signature scheme provides 1024 bits instead of 160 bits, allowing avoidance of the effective pattern check. However, since all of the bits cannot be stored in the D register from the beginning because they exceed 160 bits, starting signature calculation is impossible.

After initialization, calculation of A² mod N is conducted (Step 314). The initial value of A is 1.

Afterwards, calculation of A×D mod N is conducted (Step 314). D takes either of two values in conformity with the value of Kc (a bit of the key K at a position indicated by the key counter (KC) 152).
if Kc=1 then D=D
if Kc=0 then D=1

D is generated by the hardware gate 156 from the digest data D read out from the digest register D120 and the Kc read out from the key register 130 using the key counter (KC) 152. According to the OP code table of FIG. 4-2(b), an MDK instruction is an instruction for decreasing the key counter by one and providing the aforementioned D at the same time.

The key K of interest does not appear directly. However, it influences D in ‘_A×D^{K} mod N−>A’ indirectly. The K, which should be completely protected from leakage to the outside, influences calculation of A×D^{K} mod N indirectly.

Two mod calculations (Steps S314 and S316) are conducted by repeating decreasing the key counter KC 152 (Step S320) by one for the length of the key K, in other words, until the count of the key counter KC 152 is zero (YES in Step S318). When the key counter KC 152 turns zero, the SF0 is reset to zero, causing to leave the subroutine for this signature calculation (SIE instruction).

The intermediary calculation results, which are stored in a specific area, are overwritten one after another. After completion of this signature calculation, data with a signature as the final result is stored.

The aforementioned mod calculations (Steps S314 and S316) have a loop structure of multiple computing steps including a multiplication instruction as a primary instruction. While calculation of mod N is generally based on division, calculation called Montgomery Multiplication, which includes multiple multiplications and a single subtraction, is carried out here. See Non-Patent Reference 1 (3.8 Montgomery's Method, pp. 46 and 47) for the Montgomery Multiplication algorithm.

(Procedure for Montgomery Multiplication)

The following expression is given for the Montgomery Multiplication of A D^{K} mod N (note that when subtraction of N in this expression is impossible, it is not conducted.)

$$( \frac{\begin{matrix}[ \{ {AR}^{*} + ( {AR}^{*} {N}^{*} mod R ) N \} / R - N ] \underline{D} + \\ [ \{ {AR}^{*} + ( {AR}^{*} {N}^{*} mod R ) N \} / R - N ] \underline{D} {N}^{*} mod RN\end{matrix}}{R} ) - N$$

Where R, R*, and N* are constants, which can be obtained at the same time as the initial setting when N is given. According to a practical RSA public-key cryptosystem, the public parameter N is fixed to a length of 1024 bits, and thus R, R*, and N* are as given below.

R=2¹⁰²⁴=100000 . . . 000

(The bit-length of data R is 1025 bits.)

R*=R² mod N=2²⁰⁴⁸ mod N

(Due to calculation of mod N, the bit-length of data R* is 1024 bits or less.)

Calculation for N is conducted so as to satisfy NN* =γR−1, where γ denotes an arbitrary integer.

(The bit-length of data N* is 1024 or less.)

The expression includes three divisions by R and three calculations of mod R. However, since the value of R is of a special form of 2¹⁰²⁴, those calculations can be replaced with bit operations.

Since the shaded portions in the expression being the same, the procedure for calculating the expression described above is as given below.

(01) Calculate AR*. Result of this multiplication is a maximum of 2048 bits.

(02) First, calculate AR* mod R (extract the lower L bits) because calculation of

AR* N* leads to overflow even if there are 2048 bits. Discard the upper half 1024 bits.

(03) Calculate (02)×N*. Result of this multiplication is a maximum of 2048 bits.

(04) Calculate (03) mod R (extract the lower L bits). Discard the upper half 1024 bits.

(05) Calculate (04)×N. Result of this multiplication is a maximum of 2048 bits.

(06) Calculate (01)+(05). Result of this addition is a maximum of 2049 bits.

(07) Calculate (06)/R (discard the lower L bits of 0). Discard the lower half 1024 bits.

(08) Calculate (07)−N, and represent the resulting value by X. This subtraction is conducted by determining whether the sign is positive or negative and then selecting.

(09) Calculate (08)×D (which is influenced by Kc). Result of this multiplication is 1184 bits (=1024+160).

(10) First, calculate (09) mod R (extract the lower L bits) because calculation of (09)

N* leads to overflow even if there are 2048 bits. Extract the lower half 1024 bits.

(11) Calculate (10)×N. Result of this multiplication is a maximum of 2048 bits.

(12) Calculate (11) mod R (extract the lower L bits). Extract the lower half 1024 bits.

(13) Calculate (12)×N. Result of this multiplication is a maximum of 2048 bits.

(14) Calculate (09)+(1,3). Result of this addition is a maximum of 2049 bits.

(15) Calculate (14)/R (discard the lower L bits). Discard the lower half 1024 bits.

(16) Calculate (15)−N. This subtraction is conducted by determining whether the sign is positive or negative and then selecting.

Note that the meaning of ‘determining whether the sign is positive or negative and then selecting’ in (08) and (16) is that the resulting value itself is used as the answer if the result of subtraction is positive, while if the resulting value is negative, the value is discarded and the previous value before that subtraction is selected as the answer.

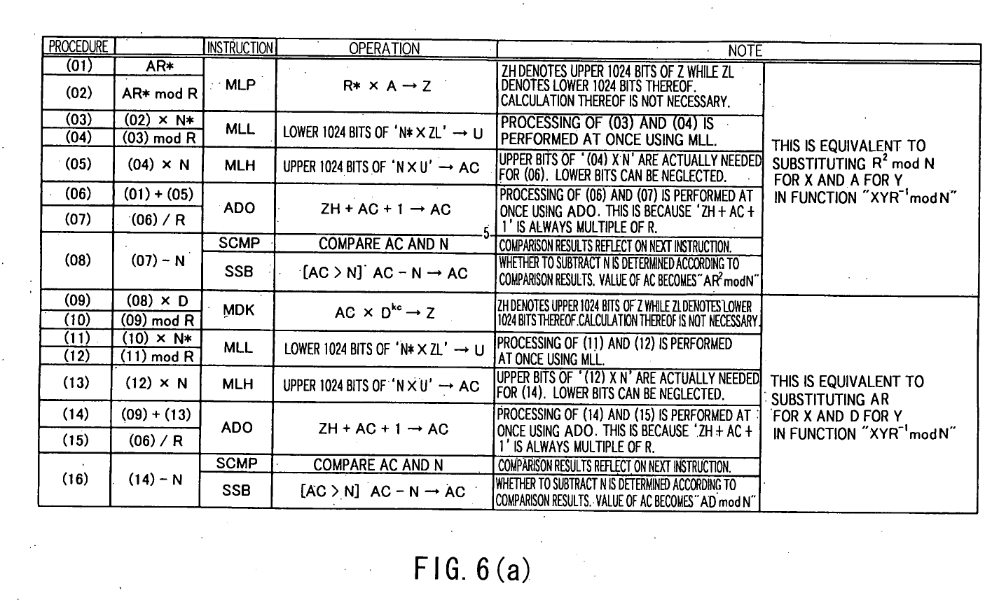

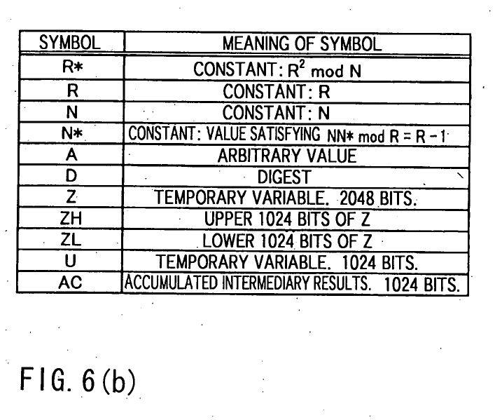

A case of calculating the expression described above using the instructions in the OP code tables of FIG. 4-1(a) and FIG. 4-1(b) is shown in FIG. 6(a). The meanings of symbols in FIG. 6(a) are given in FIG. 6(b).

As shown in FIG. 6(a), the entire procedure described above can be performed using the instructions shown in FIGS. 4-1 and 4-2 that are effective when in the security mode.

<Application to IC Cards>

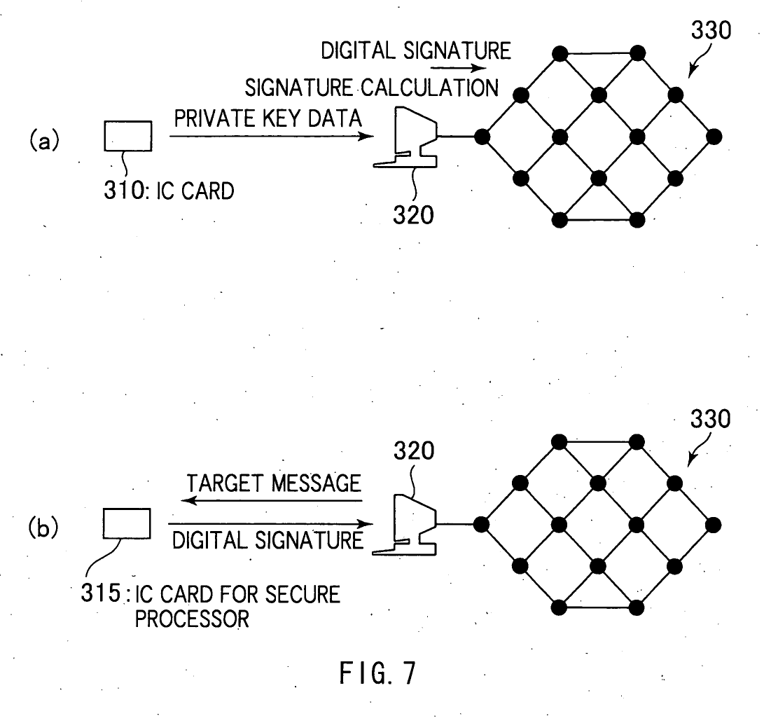

Referencing FIG. 7, an application of the secure processor to IC cards is described.

A digital signature is generated by ciphering digest data generated from a target message using a private key as described above. FIG. 7(a) shows an available authentication IC card 310. Private key data is stored in this authentication IC card 310. A message sender sets it on a card reader (not shown in the drawings) attached to a personal computer 320 and then clicks a button indicating a signature operation on the display of the personal computer 320 to start the signature operation. As a result, the private key data is read out from the authentication IC card 310, a digital signature is generated within the personal computer 320, and it is paired with the message body and sent to a destination via the Internet 330. After completion of signature calculation, removal of the IC card from the card reader completes the entire signature operation.

With this operation, the security level differs according to the position in which signature calculation is conducted. According to the method shown in FIG. 7(a), there is a risk of private key data being wiretapped or copied even within the short period that the private key data is being transferred to the personal computer.

Since the IC card 315 including the secure processor shown in FIG. 7(b) is capable of signature calculation, the IC card 315 can retrieve a target message, conducting signature calculation therewithin. Data retrieved into the IC card 315 may be digest data. What is transferred from the IC card 315 to the personal computer 320 and then output therefrom is the results of digital signature other than the key data. Since signature calculation is conducted within the IC card, the key data need not be read out and there is no aforementioned risk. Backward calculation of a key using the signature results takes an astronomic amount of time.

Furthermore, even if any kind of program means (including computer virus, Cracker, etc.) are used against the secure processor IC card 315, extracting key data itself from the IC card, copying, measuring, observing, and/or related acts are difficult and impossible.

1. A secure processor, comprising:
a key register including non-volatile memory stored with key data;
a key counter configured to indicate a bit position of the key data stored in the key register to access the key data bit by bit;
a digest register configured to be stored with digest data to be used for digital signature; and
a gate configured to output 1 for the content of the digest register when the corresponding bit of the key data accessed by the key counter is 0 and output the content of the digest register as is when the bit of the key data is 1;
wherein no path for reading all data out from the outside is prepared for the key register, and the secure processor further comprises a plurality of signature dedicated instructions for controlling the key register, the key counter, and the digest register to obtain a digital signature based on the digest data, as well as general instructions.

2. The secure processor according to claim 1, further comprising:
a general mode and a security mode as processor running modes;
a security register configured to indicate the security mode; and
a general instruction for setting a security mode and a signature dedicated instruction for resetting the same; wherein
the general instruction is effective during the general mode while the signature dedicated instruction is effective during the security mode.

3. The secure processor according to claim 2, wherein
the instruction for setting the security mode causes to set the security register and initializes the key counter to 1023 at the same time; and
the signature dedicated instruction causes to decrease the key counter by one at the same time when an instruction for conducting signature calculation for one bit of the key register, and causes to reset the security mode only when the key counter is 0 resulting from the signature calculation progressing bit by bit.

4. The secure processor according to claim 3, further comprising a means for detecting that each 16 bits of digest data stored in the digest register includes at least one ‘1’; wherein the instruction for setting the security mode causes to initialize the key counter when at least one ‘1’ is included in each 16 bits, and causes to prevent change in data in the digest register after the security register is set.

5. The secure processor according to claim 3, wherein
the secure processor is connected to main memory; and the signature dedicated instruction causes to store results of digital signature calculation only in a specific area of the main memory and write the results of digital signature calculation over previous calculation results.

6. An IC card including a secure processor according to either of claims 1 to 5 and 7.

7. The secure processor according to claim 4, wherein
the secure processor is connected to main memory; and the signature dedicated instruction causes to store results of digital signature calculation only in a specific area of the main memory and write the results of digital signature calculation over previous calculation results.
